(19) United States
(12) Patent Application Publication
(10) Pub. No.: US 2024/0410999 A1
(43) Pub. Date: Dec. 12, 2024

(54) TECHNIQUES FOR A FREE SPACE SILICON PHOTONICS RECEIVER FOR FMCW LIDAR

(71) Applicant: AEVA, INC., Mountain View, CA (US)

(72) Inventors: Ryan Going, Los Altos, CA (US); Bing Shen, Sunnyvale, CA (US); Pradeep Srinivasan, Fremont, CA (US)

(21) Appl. No.: 18/207,384

(22) Filed: Jun. 8, 2023

(51) Int. Cl. G01S 7/4915; G01S 7/481; G01S 17/58

(52) U.S. Cl. CPC G01S 7/4915; G01S 7/4816; G01S 7/4817; G01S 17/58

(57) ABSTRACT

A frequency-modulated continuous-wave (FMCW) light detection and ranging (LiDAR) system includes an optical source to direct optical beams towards a target object, and a plurality of return signals are returned to the LiDAR system. The LiDAR system includes a reflective optical component to return a portion of the plurality of optical beams along a return path as a local oscillator (LO) signal, a rotating scanning mirror between the optical source and the target object, and a plurality of optical detectors. The plurality of optical detectors receives and consumes the plurality of return signals. The LiDAR system also includes an optical circuit implemented on a photonics chip that include a plurality of photonics couplers. The plurality of photonics couplers produces a plurality of outputs that are combined by the optical circuit. A signal processing system consumes the outputs.

### FIELD

The present disclosure is related to LiDAR (light detection and ranging) systems in general, and more particularly to the use of photonic couplers.

### BACKGROUND

Frequency-Modulated Continuous-Wave (FMCW) LiDAR systems use tunable, infrared lasers for frequency-chirped illumination of targets, and coherent receivers for detection of backscattered or reflected light from the targets that are combined with a local copy of the transmitted signal. Mixing the local copy with the return signal, delayed by the round-trip time to the target and back, generates signals at the receiver with frequencies that are proportional to the distance to each target in the field of view of the system. Electrical components and photonic components can be incorporated into one or more chips for use in a LiDAR system.

### SUMMARY

The present disclosure describes examples of systems and methods for using photonics couplers in FMCW LiDAR systems. In one embodiment of the present disclosure, an improved arrangement of photonics couplers is described. In some embodiments, separate photonics couplers couple local oscillator (LO) and Signal onto single mode waveguides, which are then mixed through a 2×2 optical combiner. In some embodiments, separate photonics couplers couple LO and Signal onto single mode waveguides, which are then combined with a 90° optical hybrid. In some embodiments, an on-chip or edge-coupled off-chip LO, along with a Signal, is combined with a 90° optical hybrid.

### BRIEF DESCRIPTION OF THE DRAWINGS

For a more complete understanding of various examples, reference is now made to the following detailed description taken in connection with the accompanying drawings in which like identifiers correspond to like elements:

FIG. 1 is a block diagram illustrating an example LiDAR system according to embodiments of the present disclosure;

FIG. 2 is a time-frequency diagram of an FMCW scanning signal that can be used by a LiDAR system to scan a target environment according to some embodiments;

FIG. 3 is a block diagram illustrating a Michaelson interferometry-based frequency modulated continuous-wave (FMCW) receiver according to embodiments of the present disclosure;

FIG. 4A is an example illustration of an overlap of signal mode and LO mode for FMCW LiDAR, in which the two beams, LO and SIGNAL, are incident on the photodiode with an overlap;

FIG. 4B is an example illustration of an overlap of signal mode and photonics coupler PC mode for FMCW LiDAR according to embodiments of the present disclosure, in which the two beams, LO and SIGNAL, are incident on the photonics coupler mode;

FIG. 5 is a block diagram illustrating an example LiDAR system according to embodiments of the present disclosure;

FIG. 6 is an example illustration of multiple beams and multiple photonic couplers for FMCW LiDAR according to embodiments of the present disclosure.

FIG. 7 is a block diagram illustrating separate photonics couplers for LO and Signal, according to embodiments of the present disclosure.

FIG. 8 is a block diagram illustrating separate photonics couplers for LO and Signal, with detection of in-phase and quadrature versions of the mixed signal, according to embodiments of the present disclosure;

FIG. 9 is a block diagram illustrating separate photonics couplers for LO and Signal, with detection of in-phase and quadrature versions of the mixed signal, according to embodiments of the present disclosure;

FIG. 10 is a flow diagram of a method of operating a LiDAR system, according to embodiments of the present disclosure.

FIG. 11 is a block diagram of an example computing device that may perform one or more of the operations described herein, in accordance with aspects of the disclosure.

### DETAILED DESCRIPTION

The present disclosure describes various examples of engineering and applying photonics couplers to improve signal-to-noise ratio (SNR) and coupling efficiency. According to some embodiments, the described LiDAR system described herein may be implemented in any sensing market, such as, but not limited to, transportation, manufacturing, metrology, medical, virtual reality, augmented reality, and security systems. According to some embodiments, the described LiDAR system is implemented as part of a front-end of frequency modulated continuous-wave (FMCW) device that assists with spatial awareness for automated driver assist systems, or self-driving vehicles.

In some embodiments, LiDAR systems include coherent scan technology that includes the use of transmission lines, one or more sensors, receivers, and at least one local oscillator, i.e., a local copy of the transmission line. A scanning element, e.g., galvo mirror, can be used to transmit the beam of light towards targets in the field of view of a sensor used by LiDAR systems described herein. A beam reflected from the target can be collected by a lens system and combined with the local oscillator. As mirror speeds are increased, mirror movement during the round-trip time to and from a target, especially for distant targets, can cause light returned from the target to be slightly off angle with respect to a scanning mirror at the time of the arrival of the returned light at a receiver. The (optical) lag angle can result in degradation of the signal-to-noise ratio at sensors of the receiver. This optical lag angle is sometimes also referred to as descan. Using the techniques described herein, embodiments of the present invention can, among other things, address the issues described above by providing an expanded field of view of the receiver on a LiDAR system. Multiple waveguides can be provided on a substrate or photonics chip to receive returned beams having different lag angles to increase the field of view of a receiver.

In some embodiments, LiDAR systems can use a photonics coupler, rather than free space photodiodes, to couple the LO and return signal (Signal) into a single mode waveguide connected to a waveguide photodetector. With a photonics coupler, after the LO and Signal are coupled into a single-mode waveguide, the optical coupling efficiency for a waveguide photodiode can approximate 1.00. As discussed more fully below, in some embodiments, if the waveguide coupling efficiency for the signal beam can be improved over the free space mixing efficiency, for the same system, the result is an improved signal-to-noise ratio (SNR), provided enough LO signal can be supplied to ensure shot-noise limited detection. Shot noise comes from the discrete nature of photons in an optical signal. In the absence of other noise sources, such as thermal noise, this can be the ultimate noise limit for an optical signal. Thermal noise typically comes from electronic sources such as the photodiode itself, amplifiers, or other components in the electronic chain of the receiver. Thus, when a receiver is said to be “shot noise limited,” it implies that the SNR is near a theoretical maximum. Coherent receivers are typically made shot noise limited by increasing LO power sufficiently, since increasing LO power increases the shot noise power in the denominator as well as proportionately increasing the mixed-signal in the numerator. A system is considered shot noise limited when the shot noise term, i.e., is an order of magnitude larger than other noise terms. The level of LO power at which this occurs is specific to a given system implementation.

In some embodiments, a photonics coupler Rx unit can be extended in a number of ways:

In some embodiments employing a multi-beam system, multiple photonics coupler Rx units can be aligned with the multiple beam positions.

In some embodiments, separate photonic couplers can capture LO and Signal. The two components can then be combined in a balanced receiver.

In some embodiments, separate photonic couplers can capture LO and Signal, and in conjunction with a waveguide-based 90° optical hybrid, enable IQ detection. IQ detection is a receiver architecture that enables detecting the full complex valued description of the beat signal, or beat frequency, which in reality is a complex exponential rather than a sine or cosine function. As such it is sometimes called a complex receiver. Knowing both frequency and phase provide additional information to a digital signal processor (DSP), which can be useful for further processing.

Embodiments may operate with different or fewer electronic components. Additionally, although depicted as separate components, the electronic components may be incorporated into one or more circuits or software, or a combination of circuits and software.

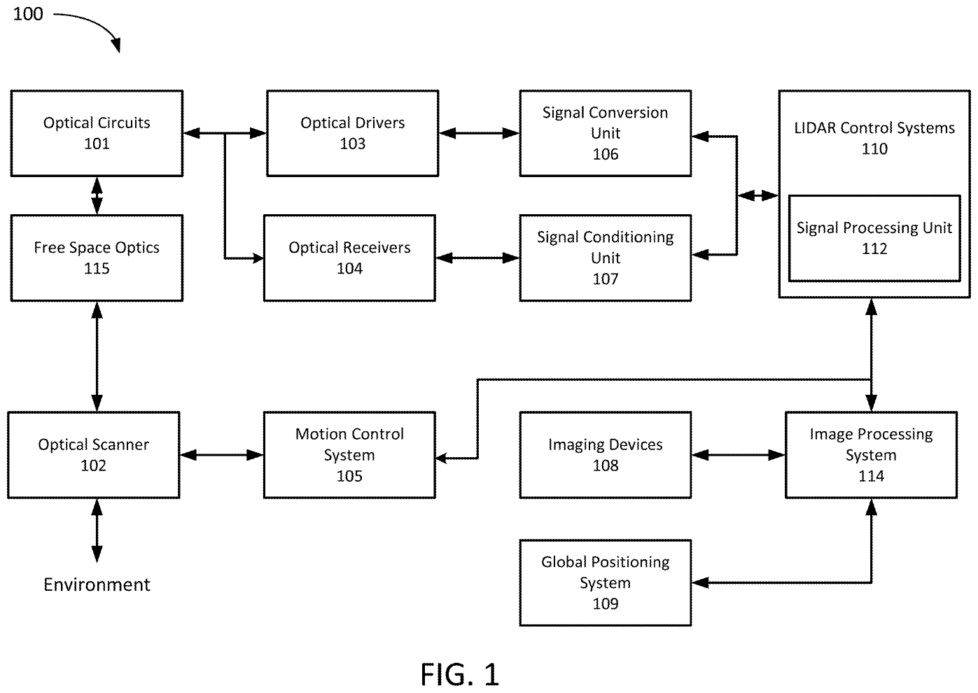

FIG. 1 is a block diagram illustrating an example LiDAR system 100 according to embodiments of the present disclosure. The LiDAR system 100 includes one or more of each of a number of components but may include fewer or additional components than shown in FIG. 1. One or more of the components depicted in FIG. 1 can be implemented on a photonics chip, according to some embodiments. The optical circuit 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis, e.g., a fast-axis.

In some examples, the LiDAR system 100 includes an optical scanner 102 that includes one or more scanning mirrors that are rotatable along an axis, e.g., a slow-axis, that is orthogonal or substantially orthogonal to the fast-axis of the diffractive element to steer optical signals to scan an environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuit 101. For example, the return optical beam may be directed to an optical detector by a polarization beam splitter. In addition to the mirrors and galvanometers, the optical scanner 102 may include components such as a quarter-wave plate, lens, anti-reflective coated window or the like.

To control and support the optical circuit 101 and optical scanner 102, the LiDAR system 100 includes LiDAR control systems 110. The LiDAR control systems 110 may include a processing device for the LiDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LiDAR control systems 110 may include a signal processing unit 112 such as a DSP. The LiDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuit 101 to drive optical sources such as lasers and amplifiers. In some examples, several optical drivers 103 and signal conversion units 106 may be provided to drive multiple optical sources.

The LiDAR control systems 110 are also configured to output digital control signals for the optical scanner 102. A motion control system 105 may control the galvanometers of the optical scanner 102 based on control signals received from the LiDAR control systems 110. For example, a digital-to-analog converter may convert coordinate routing information from the LiDAR control systems 110 to signals interpretable by the galvanometers in the optical scanner 102. In some examples, a motion control system 105 may also return information to the LiDAR control systems 110 about the position or operation of components of the optical scanner 102. For example, an analog-to-digital converter may in turn convert information about the galvanometers' position to a signal interpretable by the LiDAR control systems 110.

The LiDAR control systems 110 are further configured to analyze incoming digital signals. In this regard, the LiDAR system 100 includes optical receivers 104 to measure one or more beams received by optical circuit 101. For example, a reference beam receiver may measure the amplitude of a reference beam from the active optical component, and an analog-to-digital converter converts signals from the reference receiver to signals interpretable by the LiDAR control systems 110. Target receivers within the optical receivers 104 measure the optical signal that carries information about the range and velocity of a target in the form of a beat frequency, a modulated optical signal. The reflected beam may be mixed with a second signal from a local oscillator. The optical receivers 104 may include a high-speed analog-to-digital converter to convert signals from the target receiver to signals interpretable by the LiDAR control systems 110. In some examples, the signals from the optical receivers 104 may be subject to signal conditioning by signal conditioning unit 107 prior to receipt by the LiDAR control systems 110. For example, the signals from the optical receivers 104 may be provided to an operational amplifier for amplification of the received signals and the amplified signals may be provided to the LiDAR control systems 110.

In some applications, the LiDAR system 100 may additionally include one or more imaging devices 108 configured to capture images of the environment, a global positioning system 109 configured to provide a geographic location of the system, or other sensor inputs. The LiDAR system 100 may also include an image processing system 114. The image processing system 114 can be configured to receive the images and geographic location, and send the images and location or information related thereto to the LiDAR control systems 110 or other systems connected to the LiDAR system 100.

In operation according to some examples, the LiDAR system 100 is configured to use nondegenerate optical sources to simultaneously measure range and velocity across two dimensions. This capability allows for real-time, long-range measurements of range, velocity, azimuth, and elevation of the surrounding environment.

In some examples, the scanning process begins with the optical drivers 103 and LiDAR control systems 110. The LiDAR control systems 110 instruct, e.g., via signal processor unit 112, the optical drivers 103 to independently modulate one or more optical beams, and these modulated signals propagate through the optical circuit 101 to the free space optics 115. The free space optics 115 directs the light at the optical scanner 102 that scans a target environment over a preprogrammed pattern defined by the motion control system 105. The optical circuit 101 may also include a polarization wave plate (PWP) to transform the polarization of the light as it leaves the optical circuit 101. In some examples, the polarization wave plate may be a quarter-wave plate or a half-wave plate. A portion of the polarized light may also be reflected back to the optical circuit 101. For example, lensing or collimating systems used in LiDAR system 100 may have natural reflective properties or a reflective coating to reflect a portion of the light back to the optical circuit 101.

Optical signals reflected back from an environment pass through the optical circuit 101 to the optical receivers 104. Because the polarization of the light has been transformed, it may be reflected by a polarization beam splitter along with the portion of polarized light that was reflected back to the optical circuit 101. In such scenarios, rather than returning to the same fiber or waveguide serving as an optical source, the reflected signals can be reflected to separate optical receivers 104. These signals interfere with one another and generate a combined signal. The combined signal can then be reflected to the optical receivers 104. Also, each beam signal that returns from the target environment may produce a time-shifted waveform. The temporal phase difference between the two waveforms generates a beat frequency measured on the optical receivers 104, e.g., photodetectors.

The analog signals from the optical receivers 104 are converted to digital signals by the signal conditioning unit 107. These digital signals are then sent to the LiDAR control systems 110. A signal processing unit 112 may then receive the digital signals to further process and interpret them. In some embodiments, the signal processing unit 112 also receives position data from the motion control system 105 and galvanometers (not shown) as well as image data from the image processing system 114. The signal processing unit 112 can then generate 3D point cloud data that includes information about range and/or velocity points in the target environment as the optical scanner 102 scans additional points. The signal processing unit 112 can also overlay 3D point cloud data with image data to determine velocity and/or distance of objects in the surrounding area. The signal processing unit 112 also processes the satellite-based navigation location data to provide data related to a specific global location.

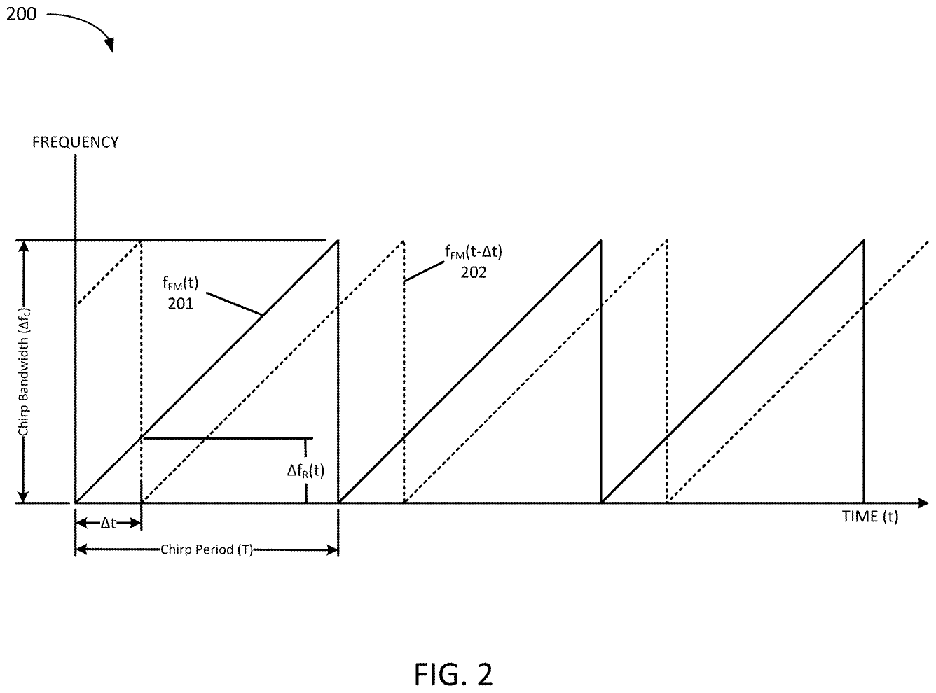

FIG. 2 is a time-frequency diagram 200 of an FMCW scanning signal 201 that can be used by a LiDAR system, such as system 100, to scan a target environment according to some embodiments. In one example, the scanning waveform 201, labeled as fFM(t), is a sawtooth waveform (sawtooth “chirp”) with a chirp bandwidth ΔfC and a chirp period TC. The slope of the sawtooth is given as k=(ΔfC/TC). FIG. 2 also depicts target return signal 202 according to some embodiments. Target return signal 202, labeled as fFM(t−Δt), is a time-delayed version of the scanning signal 201, where Δt is the round-trip time to and from a target illuminated by scanning signal 201. The round-trip time is given as Δt=2R/v, where R is the target range and v is the velocity of the optical beam, which is the speed of light c. The target range, R, can therefore be calculated as R=c(Δt/2). When the return signal 202 is optically mixed with the scanning signal, a range dependent difference frequency (“beat frequency”) ΔfR(t) is generated. The beat frequency ΔfR(t) is linearly related to the time delay Δt by the slope of the sawtooth k. That is, ΔfR(t)=kAt. Since the target range R is proportional to Δt, the target range R can be calculated as R=(c/2)(ΔfR(t)/k). That is, the range R is linearly related to the beat frequency ΔfR(t). The beat frequency ΔfR(t) can be generated, for example, as an analog signal in optical receivers 104 of system 100. The beat frequency can then be digitized by an analog-to-digital converter (ADC), for example, in a signal conditioning unit such as signal conditioning unit 107 in LiDAR system 100. The digitized beat frequency signal can then be digitally processed, for example, in a signal processing unit, such as signal processing unit 112 in system 100. It should be noted that the target return signal 202 will, in general, also includes a frequency offset (Doppler shift) if the target has a velocity relative to the LiDAR system 100. The Doppler shift can be determined separately and used to correct the frequency of the return signal, so the Doppler shift is not shown in FIG. 2 for simplicity and ease of explanation. It should also be noted that the sampling frequency of the ADC will determine the highest beat frequency that can be processed by the system without aliasing. In general, the highest frequency that can be processed is one-half of the sampling frequency, i.e., the “Nyquist limit”. In some embodiments, if the sampling frequency of the ADC is 1 gigahertz, then the highest beat frequency that can be processed without aliasing (ΔfRmax) is 500 megahertz. This limit in turn determines the maximum range of the system as Rmax=(c/2)(ΔfRmax/k) which can be adjusted by changing the chirp slope k. In one example, while the data samples from the ADC may be continuous, the subsequent digital processing described below may be partitioned into “time segments” that can be associated with some periodicity in the LiDAR system 100. In some embodiments, a time segment might correspond to a predetermined number of chirp periods T, or a number of full rotations in azimuth by the optical scanner.

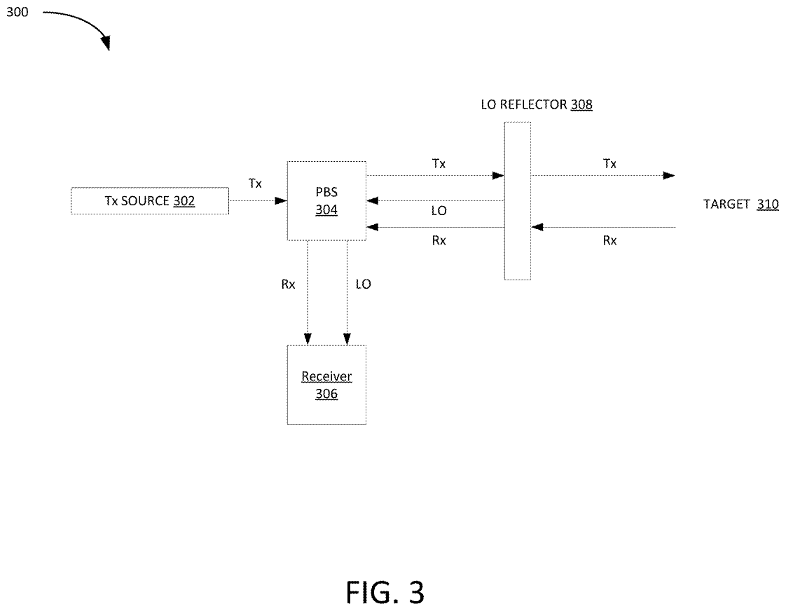

Embodiments described below with respect to FIGS. 3-11 may be used, at least in part, to produce and operate an FMCW LiDAR system as described with respect to FIGS. 1 and 2 above.

FIG. 3 is a block diagram 300 illustrating a Michaelson interferometry-based FMCW receiver according to embodiments of the present disclosure. Block diagram 300 includes electrical and photonics components that operate together to generate a frequency chirped output beam from a transmitter (Tx) source 302. In some embodiments, the transmitter source 302 is a laser diode. After passing through a polarizing beam splitter 304, a small portion of the Tx beam is reflected back from a local oscillator reflector 308, as a local oscillator signal (LO), onto a photodiode within a receiver 306 at a known short distance (LO), while the target 310 reflects the majority of the Tx beam from a longer distance (SIGNAL) onto the photodiode. The two beams, LO and SIGNAL, when incident on the photodiode, produce photocurrent proportional to their optical power, which can be proportional to the area integral of the electric field of the optical beams, as seen in equations (1) and (2). In the following equations, P represents optical power, E represents an electric field, G represents a normalized electric field of an optical mode emitted by the photonic coupler, A represents an area, c is the speed of light, ε₀ is the permittivity of free space, and η represents an efficiency ratio of the overlap integral of the mixed product relative to the total power incident.

$${P}_{LO} = \frac{c {ε}_{0}}{2} \int \int {\vert {E}_{LO} \vert}^{2} dA \qquad ( 1 )$$

$${P}_{SIG} = \frac{c {ε}_{0}}{2} \int \int {\vert {E}_{SIG} \vert}^{2} dA \qquad ( 2 )$$

A photodiode is a square-law detector, meaning that when it detects two overlapping optical fields, the electrical signal produced is the square of the sum of the two electric fields. This produces a DC term proportional to the optical power of each beam, as well as a mixed term with an amplitude proportional to the product of the optical powers of each beam and frequency which is the difference between the two optical frequencies (and is proportional to wavelength). In this sense it is a mixer. The useful beat signal between LO and SIGNAL produced by the photodiode mixer can be proportional to the overlap integral of their optical fields on the face of the photodiode, as in equation (3).

$${P}_{Mixed}^{2} = \frac{c {ε}_{0}}{2} \int \int {\vert {E}_{SIG} {E}_{LO} \vert}^{2} dA \qquad ( 3 )$$

The ratio of the overlap integral to the direct product can be referred to as “mixing efficiency” in equation (4).

$${η}_{mixing} = \frac{{P}_{Mixed}^{2}}{{P}_{SIG} {P}_{LO}} \qquad ( 4 )$$

If P_{LO}>>P_{SIG}, i.e., P_{LO} is at least an order of magnitude greater than P_{SIG}, e.g., P_{LO} is more than 10 dB greater than P_{SIG}, and the system is shot-noise limited, then the signal to noise ratio (SNR) can be proportional to the mixing efficiency η_{mixing} multiplied by the return signal power P_{SIG} as seen in equation (5).

$$SNR = \frac{{R}^{2} {η}_{mixing} {P}_{SIG} {P}_{LO}}{2 qR ( {P}_{SIG} + {P}_{LO} ) BW} = \frac{R {η}_{mixing} {P}_{SIG}}{2 qBW} \qquad ( 5 )$$

This equation assumes that the photodetector has responsivity R, and bandwidth BW, and where q is the elementary charge constant. In some systems this mixing efficiency can be quite poor, leading to undesirable SNR loss.

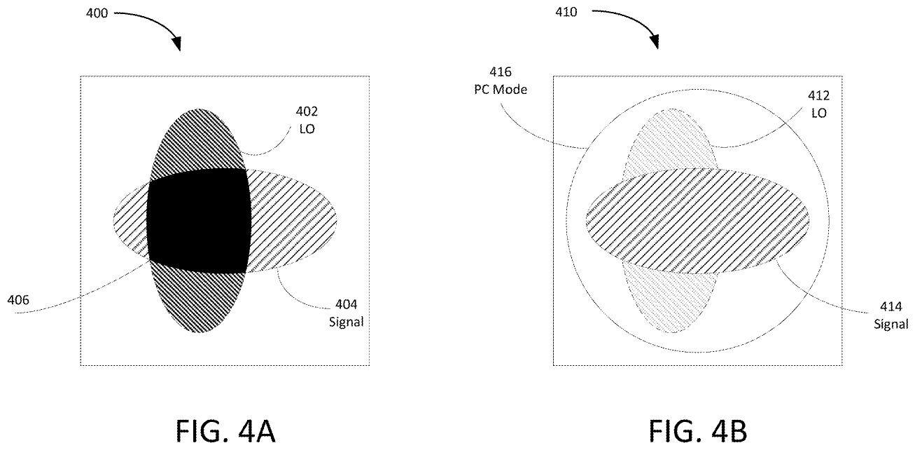

FIG. 4A is an example illustration of an overlap of signal mode and LO mode for FMCW LiDAR, in which the two beams, LO 402 and SIGNAL 404, are incident on the photodiode 400 with an overlap 406. FIG. 4A is representative of a receiver block including a free space photodiode. In the example illustration, the mixing efficiency is well below 100% or 1.00.

Coupling, with a photonics coupler, the LO and SIGNAL into a single mode waveguide connected to a waveguide photodetector can introduce coupling efficiency. Once in the waveguides the mixing efficiency between LO and signal is 100%. However, each have their own coupling efficiency to the waveguides. The net result can be better than the mixing efficiency of the free-space system. In some embodiments, the coupling efficiency approximates 1.00. In some embodiments, if the waveguide coupling efficiency for the signal beam is better than free space mixing efficiency for the same system, the result can be improved SNR, provided sufficient LO signal can be supplied to ensure shot-noise limited detection.

Maintaining a Michaelson interferometer Rx structure, as shown in FIG. 3, a silicon photonics receiver block can replace the free space photodiode block within the receiver 306. In some embodiments, for example, a photonics coupler, e.g., a grating coupler or edge coupler, can couple normal incident light (or slightly off normal incident) into a single-mode waveguide photodiode. In some embodiments, the single-mode waveguide is comprised of silicon or silicon nitride. Because the photonics coupler is a near-normal incidence photonics coupler, it can replace the normal incident free space photodiode with no or minimal changes to any optics paths in front of the photonics receiver block.

By coupling the optical power of the LO and the optical power of the SIGNAL into the single-mode waveguide, each can generate photocurrent in the waveguide photodiode. In some embodiments, the mode overlap between both the LO mode and the SIGNAL mode with the photonics coupler mode in the waveguide can be nearly perfect, and the coherent mixing efficiency approaches 1. However, one can now account for the coupling efficiency of these optical beams into the single mode waveguide through the photonics coupler, as shown in FIG. 4B. This is a mode overlap integral between the optical beam incident on the photonics coupler, and the emission mode of the photonics coupler, PC, seen in equations (6) and (7).

$${P}_{LO - PC} = \frac{c {ε}_{0}}{2} \int \int {\vert {E}_{LO} {G}_{PC} \vert}^{2} dA = {η}_{LO - PC} {P}_{LO} \qquad ( 6 )$$

$${P}_{SIG - PC} = \frac{c {ε}_{0}}{2} \int \int {\vert {E}_{SIG} {G}_{PC} \vert}^{2} dA = {η}_{SIG - PC} {P}_{SIG} \qquad ( 7 )$$

The coupling efficiency for the LO and SIGNAL (SIG) beams is the ratio of this overlap integral to the total beam power. Using the same SNR equation as for the free space photodiode case, coherent mixing efficiency can be traded for coupling efficiency on both LO and SIGNAL beams, as shown by equations (8) and (9).

$${P}_{Mixed}^{2} = {P}_{SIG - PC} {P}_{LO - PC} = {η}_{SIG - PC} {η}_{LO - PC} {P}_{SIG} {P}_{LO} \qquad ( 8 )$$

$$SNR = \frac{{R}^{2} {η}_{SIG - PC} {P}_{SIG} {η}_{LO - PC} {P}_{LO}}{2 qR ( {η}_{LO - PC} {P}_{LO} + {η}_{SIG - PC} {P}_{SIG} ) BW} = \frac{R {η}_{SIG - PC} {P}_{SIG}}{2 qBW} \qquad ( 9 )$$

If P_{LO}>>P_{SIG}, i.e., P_{LO} is at least an order of magnitude greater than P_{SIG}, e.g., P_{LO} is more than 10 dB greater than P_{SIG}, and the system remains shot-noise limited, the SNR can be proportional to the signal power and the coupling efficiency of the signal beam. In some embodiments, if the photonics coupler mode can be designed such that the coupling efficiency for the signal beam is better than the mixing efficiency in free space, then the Rx SNR will improve.

FIG. 4B is an example illustration of an overlap of signal mode and photonics coupler PC mode for FMCW LiDAR according to embodiments of the present disclosure, in which the two beams, LO 412 and SIGNAL 414, are incident on the photonics coupler 410 and the photonics coupler (PC) mode 416 of the photonics coupler 410.

In some embodiments, SNR is improved because the coupling efficiency between LO 412 and PC mode 416 can become insignificant in comparison to that between the Signal 414 and the PC mode 416, as shown in Equation (9).

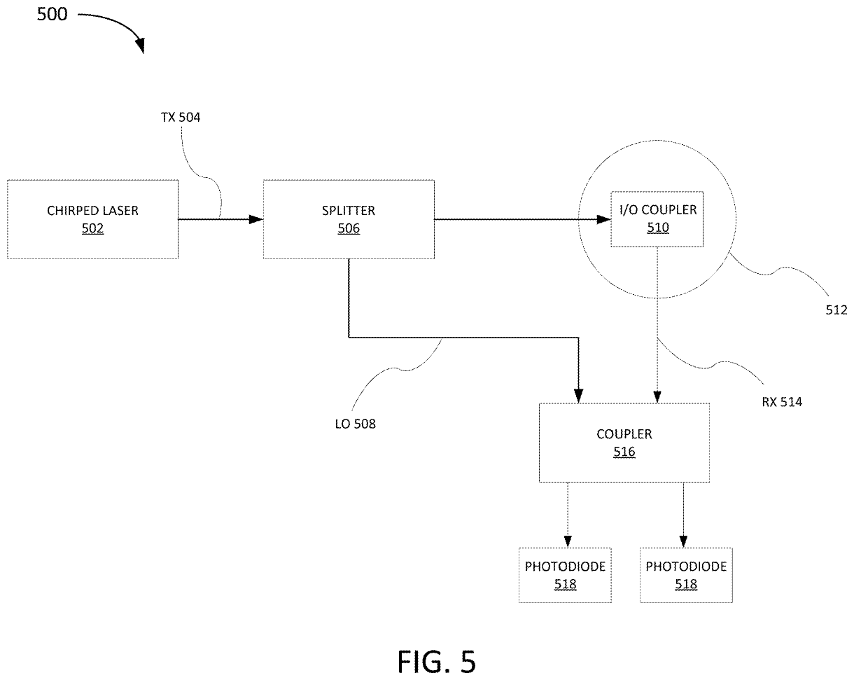

FIG. 5 is a block diagram illustrating an example LiDAR system 500 according to embodiments of the present disclosure. In the example, a chirped laser 502 transmits a beam 504 (TX) that passes through an I/O coupler 510 and then through a collimating lens 512 towards a target. In some embodiments, the outgoing beam may pass through a Faraday rotator to rotate the polarization. In some embodiments, a waveplate is used to rotate the polarization. In some embodiments, a scanning element, e.g., a scanning mirror, polygon, or a combination, is placed in front of the outgoing beam to steer the field-of-view (FOV) of the sensor. In some embodiments, a portion of the transmitted beam 504 is diverted as local oscillator 508. Upon reflection from a target, a received (RX) signal 514 is delivered to a coupler 516. In some embodiments, the received signal 514 is mixed with the local oscillator 508 by the coupler 516. In some embodiments, the I/O coupler 510 is a grating coupler. In some embodiments, one or more outputs of the coupler 516 may be consumed by photodiodes 518.

In some embodiments in which a mechanical scanner is placed in the Tx beam path, two or more photonics couplers can be employed to address beam descan. In some embodiments, secondary photonics couplers and their respective coupling mode are designed to be placed in parallel with a first photonics coupler. In some embodiments, these secondary photonics couplers can have the same coupling mode profiles and can be aligned along the descan axis, such that as the beam position changes due to descan, the signal mode of the beam overlaps with the coupling mode of these secondary photonics couplers. The outputs of the set of photonics couplers can be combined in a variety of methods.

Some embodiments comprise multiple Tx and Rx beams, in which case a free space photodiode array can be used to match the LO and signal beam pitch. In some embodiments, the photonic coupler Rx design is normal incidence and can be arrayed with the same pitch as an existing free space photodiode array, requiring minimal changes to optics to accommodate.

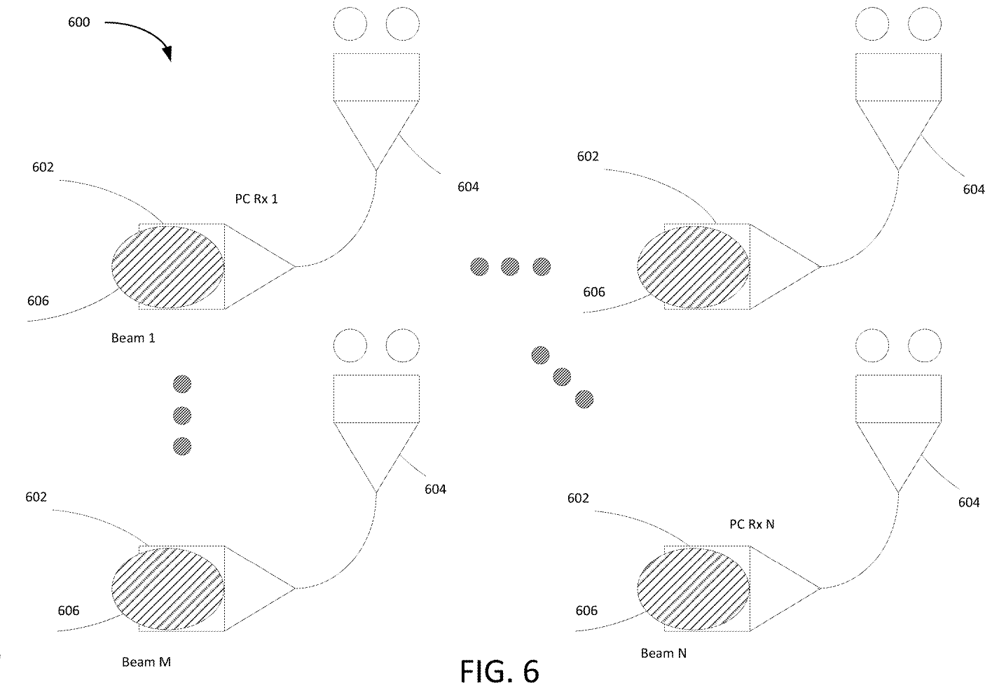

FIG. 6 is an example illustration 600 of multiple beams and multiple photonic couplers for FMCW LiDAR according to embodiments of the present disclosure.

As depicted in FIG. 6, multiple optical beams can produce modes 606, which can be consumed by an array of photonics couplers 602 and their outputs delivered to respective photodiodes 604.

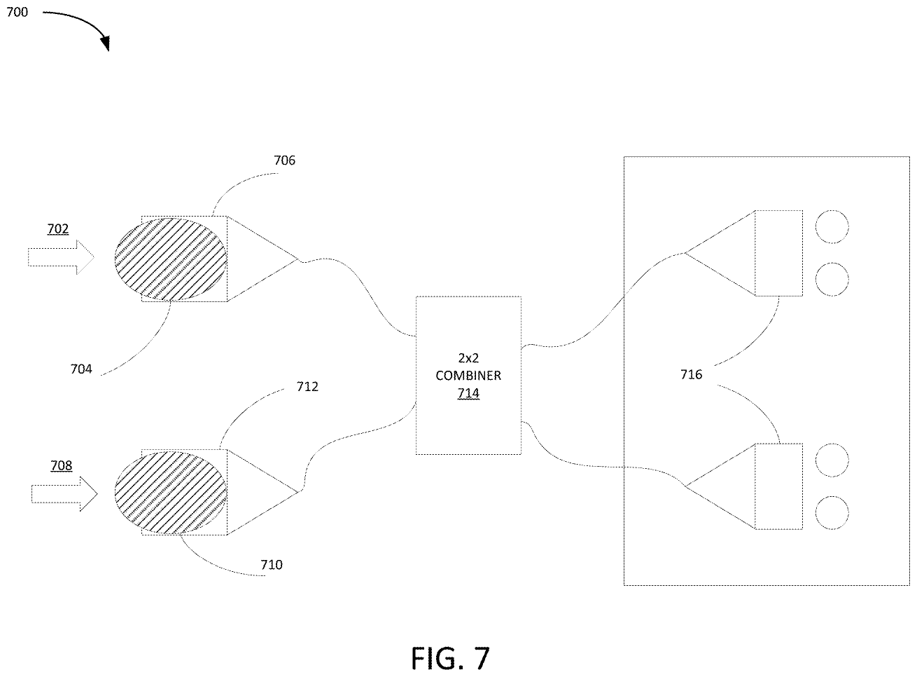

In some embodiments, a photonic coupler Rx with individual LO and Signal photonics couplers can have mode profiles tailored to match the incident LO and signal beams to maximize the coupling of each. Because the LO is reflected back along the Tx/Rx path, the LO beam can be deviated from the signal beam on the Rx without detriment to beam size or quality. This same technique can be used to separate LO and signal beams onto individual photonics couplers for a dual photonic coupler receiver, as shown in FIG. 7. As depicted in FIG. 7, both photonics couplers couple to individual single-mode waveguides, which are then mixed through a 2×2 optical combiner, with the two outputs each comprising 180° phase offset versions of the mixed LO+signal to waveguide photodetectors. Examples of such optical combiner include a 2×2 multimode interferometer (MMI) or a 50-50 directional coupler. These two photodetectors, which contain opposite phase copies of the same signal, can then be combined in a balanced or differential configuration to create a balanced or differential receiver configuration. The primary benefit can be common mode noise rejection, especially rejection of laser relative intensity noise (RIN), which appears in the more complete SNR equation (10) below, which now also includes thermal noise. RIN can arise from random fluctuations in output power from a laser. The total power of which is typically given as a fraction of the total power, e.g., RIN*P_{LO}. Since these noise fluctuations are within the LO beam, and will self-mix, the resulting noise power is the product RIN*P_{LO}². In a balanced receiver, because these two signals share the same phase, the noise power can be suppressed by the common mode rejection ratio (CMRR) of the balanced receiver, which is typically <−20 dB or better. If the 2×2 combiner and photodiodes support a reasonable common mode rejection ratio (CMRR), e.g., better than 20 dB, then the RIN can be mitigated by that amount.

Equation (10) represents a full SNR. Shot noise limited performance is achieved when 2qRP_{Lo} is larger than the rest of the terms in the denominator.

$$SNR = \frac{2 {R}^{2} {η}_{SIG - PC} {P}_{SIG} {η}_{LO - PC} {P}_{LO}}{\begin{matrix}[ {i}_{thermal}^{2} + 2 q R ( {η}_{SIG - PC} {P}_{SIG} + {η}_{LO - PC} {P}_{LO} ) + \\ {{R}^{2} ( {η}_{SIG - PC} {P}_{SIG} + {η}_{LO - PC} {P}_{LO} )}^{2} ( RIN ) ( CMRR ) ] BW\end{matrix}} \qquad ( 10 )$$

Assuming P_{LO}>>P_{SIG}:

$$SNR = \frac{2 {R}^{2} {η}_{SIG - PC} {P}_{SIG} {η}_{LO - PC} {P}_{LO}}{\begin{matrix}[ {i}_{thermal}^{2} + 2 qR {η}_{LO - PC} {P}_{LO} + \\ {R}^{2} {( {η}_{LO - PC} {P}_{LO} )}^{2} ( RIN ) ( CMRR ) ] BW\end{matrix}} \qquad ( 11 )$$

If thermal noise is represented by iₜₕₑᵣₘₐₗ², shot noise becomes 2qRη_{Lo-PC}P_{SIG}, and RIN noise is R² (η_{LO-PC}P_{LO})² (RIN)(CMRR), a shot-noise limited condition suggests:

$$2 qR {η}_{LO - PC} {P}_{LO} ≫ {i}_{thermal}^{2}$$

$$and$$

$$2 qR {η}_{LO - PC} {P}_{LO} ≫ {{R}^{2} ( {η}_{LO - PC} {P}_{LO} )}^{2} ( RIN ) ( CMRR ) ,$$

then:

$$SNR = \frac{R {η}_{SIG - PC} {P}_{SIG}}{qBW} \qquad ( 12 )$$

FIG. 7 is a block diagram 700 illustrating separate photonics couplers for LO and Signal according to embodiments of the present disclosure.

As depicted in FIG. 7, LO 702 with mode 704 is consumed by photonics coupler 706 and directed by a waveguide to 2×2 combiner 714. Similarly, signal 708 with mode 710 can be consumed by photonics coupler 712 and directed by a waveguide to 2×2 combiner 714. The outputs of the 2×2 combiner are then passed to photodiodes 716.

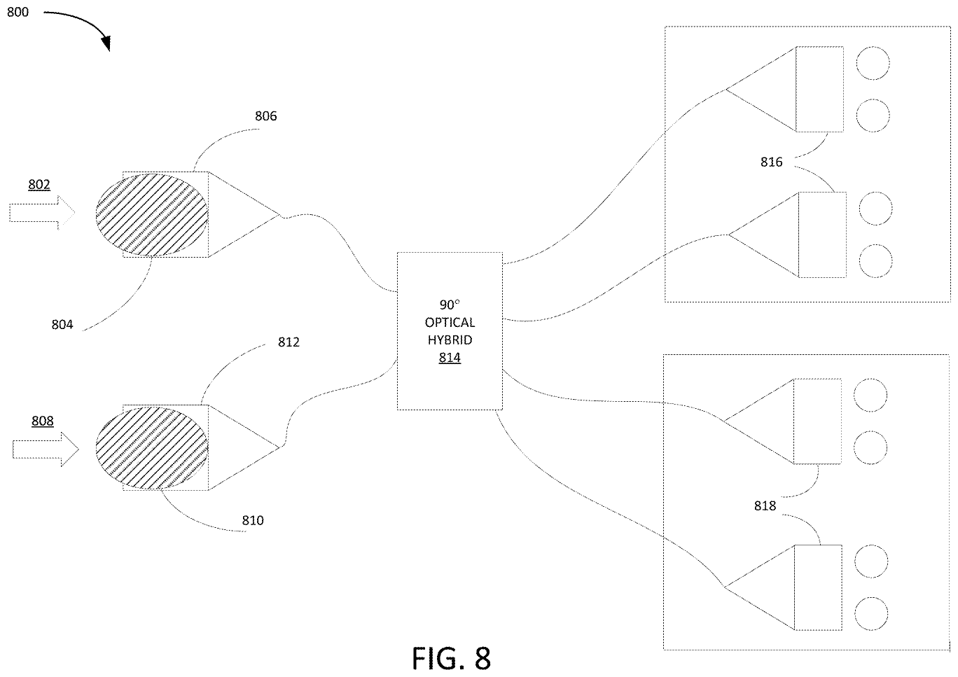

FIG. 8 is a block diagram 800 illustrating separate photonics couplers 806 and 812 for LO 808 and Signal 802, with detection of in-phase and quadrature versions of the mixed signal, according to embodiments of the present disclosure.

In some embodiments, the signal 802 and LO beam 808 can produce respective modes 804 and 810 and be consumed by respective photonics couplers 806 and 812. The outputs of the photonic couplers 806 and 812 can be combined with a 90° optical hybrid 814 that has two inputs and four outputs, the outputs then feed to two quadrature photodiodes 816 and two in-phase photodiodes 818 as depicted in FIG. 8. This can result in detection of in-phase and quadrature versions of the mixed signal, which allows recovery of the full complex representation of the original optical signals.

In some embodiments, the LO can be on the same chip as the receiver, in which it can be routed to the Rx combiner (either a 2×2 combiner or a 90° optical hybrid) through a single mode waveguide from the LO source. In some embodiments, the LO can be off-chip, but rather than be reflected back onto the chip from an LO reflector to couple through a photonics coupler, it can be coupled directly onto the chip through an edge-coupler, and then routed to the Rx with a single mode waveguide.

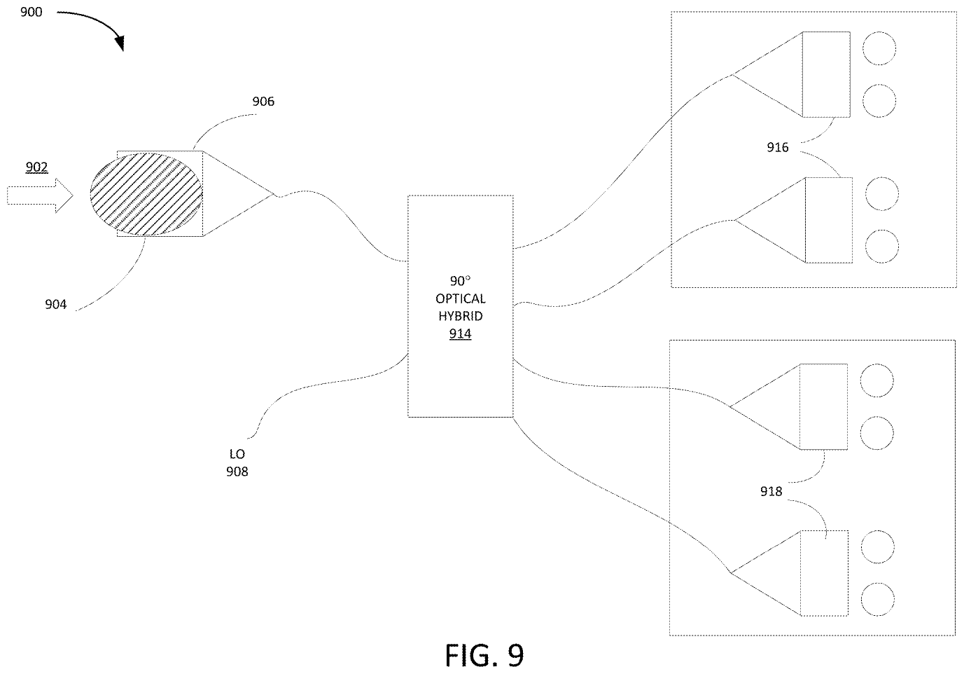

FIG. 9 is a block diagram 900 illustrating separate photonics couplers for LO 908 and Signal 902, with detection of in-phase and quadrature versions of the mixed signal, according to embodiments of the present disclosure.

As shown in FIG. 9, signal 902 produces mode 904 on photonics coupler 906, which is consumed by 90° optical hybrid 914. An LO 908 is also provided to 90° optical hybrid 914. The outputs of 90° optical hybrid 914 are delivered to two quadrature photodiodes 916 and two in-phase photodiodes 918.

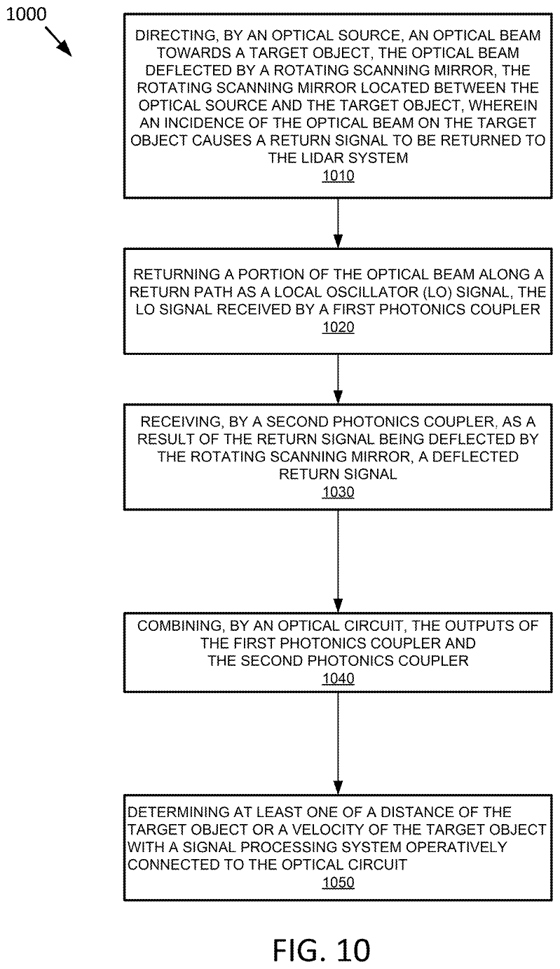

FIG. 10 is a flow diagram 1000 of a method of operating a LiDAR system, according to embodiments of the present disclosure.

Method 1000 begins at block 1010, where the method directs an optical beam from an optical source towards a target object, the optical beam deflected by a rotating scanning mirror, the rotating scanning mirror located between the optical source and the target object, wherein an incidence of the optical beam on the target object causes a return signal to be returned to the LiDAR system. In some embodiments, the optical beam may correspond to transmitter (Tx) source 302 of FIG. 3. In some embodiments, the return signal may correspond to Rx 514 of FIG. 5.

At block 1020, the method causes a portion of the optical beam to be returned along a return path as a local oscillator (LO) signal, the LO signal received by a first photonics coupler. In some embodiments, the LO signal may correspond to the LO signal 508 of FIG. 5.

At block 1030, the method receives, by a second photonics coupler, as a result of the return signal being deflected by the rotating scanning mirror, a deflected return signal. In some embodiments, the deflected return signal may correspond to the reflected signal Rx 514 of FIG. 5.

At block 1040, the method combines, by an optical circuit operatively connected to the first photonics coupler and the second photonics coupler respectively. In some embodiments, the photonic couplers may correspond to coupler 516 of FIG. 5. In some embodiments, the optical circuit may correspond to the optical circuit 101 of FIG. 1.

At block 1050, the method determines at least one of a distance of the target object or a velocity of the target object with a signal processing system operatively connected to the optical circuit. In some embodiments the signal processing system may correspond to the signal processing unit 112 of FIG. 1.

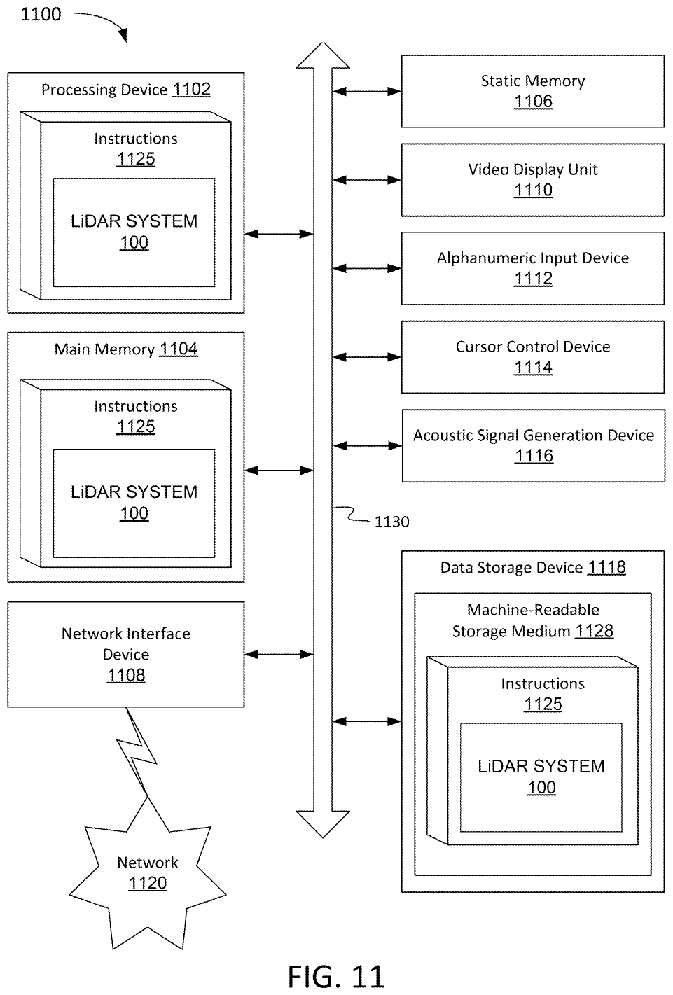

FIG. 11 is a block diagram 1100 of an example computing device that may perform one or more of the operations described herein, in accordance with aspects of the disclosure. Computing device 1100 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1100 may include a processing device, e.g., a general-purpose processor, a programmable-logic device (PLD), etc., 1102, a main memory 1104, e.g., synchronous dynamic random-access memory (DRAM) or read-only memory (ROM), a static memory 1106, e.g., flash memory, and a data storage device 1118, which may communicate with each other via a bus 1130.

Processing device 1102 may be provided by one or more general-purpose processing devices such as a microprocessor, central processing unit, or the like. In an illustrative example, processing device 1102 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1102 may also include one or more special-purpose processing devices such as an application specific integrated circuit (ASIC), a field programmable gate array (FPGA), a digital signal processor (DSP), network processor, or the like. The processing device 1102 may execute the operations described herein, in accordance with one or more aspects of the present disclosure, for performing the operations and steps discussed herein.

Computing device 1100 may further include a network interface device 1108 which may communicate with a network 1120. The computing device 1100 also may include a video display unit 1110, e.g., a liquid crystal display (LCD) or a cathode ray tube (CRT), an alphanumeric input device 1112, e.g., a keyboard, a cursor control device 1114, e.g., a mouse, and an acoustic signal generation device 1116, e.g., a speaker. In one embodiment, video display unit 1110, alphanumeric input device 1112, and cursor control device 1114 may be combined into a single component or device, e.g., an LCD touch screen.

Data storage device 1118 may include a computer-readable storage medium 1128 on which may be stored one or more sets of instructions 1125 that may include instructions for tuning the LiDAR system 100 described herein, in accordance with one or more aspects of the present disclosure. The instructions 1125 for the LiDAR system 100 may also reside, completely or at least partially, within main memory 1104 and/or within processing device 1102 during execution thereof by computing device 1100, main memory 1104 and processing device 1102 also constituting computer-readable media. The instructions 1125 for LiDAR system 100 may further be transmitted or received over a network 1120 via network interface device 1108.

While computer-readable storage medium 1128 is shown in an illustrative example to be a single medium, the term “computer-readable storage medium” should be taken to include a single medium or multiple media, e.g., a centralized or distributed database and/or associated caches and servers, that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operation may be performed, at least in part, concurrently with other operations. Instructions or sub-operations of distinct operations may be performed in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A frequency-modulated continuous-wave (FMCW) light detection and ranging (LiDAR) system, comprising:
an optical source to emit a plurality of optical beams directed towards a target object, wherein incidences of the plurality of optical beams on the target object cause a plurality of return signals to be returned to the LiDAR system;
a reflective optical component to return a portion of a first optical beam of the plurality of optical beams along a return path as a local oscillator (LO) signal;
a rotating scanning mirror between the optical source and the target object, wherein each optical beam of the plurality of optical beams is deflected by the rotating scanning mirror;
a plurality of optical detectors, each optical detector of the plurality of optical detectors receiving a portion of the plurality of return signals;
an optical circuit implemented on a photonics chip, wherein the optical circuit comprises a plurality of photonics couplers, operatively connected to the plurality of optical detectors, the plurality of photonics couplers producing a plurality of outputs, wherein the optical circuit combines the outputs of the plurality of photonics couplers; and:
a signal processing system operatively connected to the optical circuit.

2. The system of claim 1, wherein the plurality of photonics couplers is aligned along a descan axis such that as a beam position of the plurality of return signals changes due to descan, a signal mode of the plurality of return signals overlaps with a coupling mode of at least one of the plurality of photonics couplers.

3. The system of claim 1, wherein at least one of the plurality of photonics couplers is a grating coupler.

4. The system of claim 1, wherein at least one of the plurality of photonics couplers is an edge coupler.

5. The system of claim 1, wherein the plurality of optical beams are deflected by a first degree by the rotating scanning mirror and the plurality of return signals are deflected by a second degree by the rotating scanning mirror.

6. The system of claim 1, wherein the plurality of photonics couplers receives the LO signal and the plurality of return signals.

7. The system of claim 1, wherein the optical circuit is further to combine the outputs of the plurality of photonics couplers and the LO signal.

8. A method of operating a frequency-modulated continuous-wave (FMCW) light detection and ranging (LiDAR) system, the method comprising:
directing, by an optical source, an optical beam towards a target object, the optical beam deflected by a rotating scanning mirror, the rotating scanning mirror located between the optical source and the target object, wherein an incidence of the optical beam on the target object causes a return signal to be returned to the LiDAR system;
returning a portion of the optical beam along a return path as a local oscillator (LO) signal, the LO signal received by a first photonics coupler;
receiving, by a second photonics coupler, as a result of the return signal being deflected by the rotating scanning mirror, a deflected return signal;
combining, by an optical circuit, the outputs of the first photonics coupler and the second photonics coupler; and
determining at least one of a distance of the target object or a velocity of the target object with a signal processing system operatively connected to the optical circuit.

9. The method of claim 8, wherein the first photonic coupler and the second photonic coupler are grating couplers.

10. The method of claim 8, wherein the first photonic coupler and the second photonic coupler are edge couplers.

11. The method of claim 8, wherein the combining is performed by a 2×2 optical combiner, the 2×2 optical combiner providing two outputs, each of the two outputs comprising 180° phase offset versions of a mix of the LO signal and the return signal.

12. The method of claim 11, wherein the LO signal is routed to the 2×2 optical combiner with a first single mode waveguide.

13. The method of claim 12, wherein the return signal is routed to the 2×2 optical combiner with a second single mode waveguide.

14. The method of claim 11, wherein an output of the 2×2 optical combiner is a balanced signal.

15. The method of claim 8, wherein the combining is performed by a 90° optical combiner, the 90° optical combiner providing a plurality of outputs, the plurality outputs provided to a plurality of quadrature photodetectors and a plurality of in-phase photodetectors.

16. A frequency-modulated continuous-wave (FMCW) light detection and ranging (LiDAR) system, comprising:
an optical source to emit an optical beam towards a target object, wherein an incidence of the optical beam on the target object causes a return signal to be returned to the LiDAR system;
a reflective optical component to return a portion of the optical beam along a return path as a local oscillator (LO) signal;
a first photonics coupler to obtain the LO signal;
a second photonics coupler to obtain the return signal;
an optical circuit, operatively connected to the first photonics coupler and the second photonics coupler, wherein the optical circuit combines the return signal and the LO signal with a 2×2 optical combiner to generate two output signals, the two output signals comprising 180 degree phase offset versions of a combination of the return signal and LO signal; and
a signal processing system operatively connected to the optical circuit.

17. The system of claim 15, wherein the two output signals are combined in a balanced configuration to produce a balanced signal.

18. The system of claim 15, wherein the two output signals are combined in a balanced configuration to produce a differential signal.

19. The system of claim 15, wherein the LO signal is routed to the optical circuit through a single mode waveguide.

20. The system of claim 15, wherein the LO signal is routed to the optical circuit through an edge coupler.
